(19) United States
(12) Patent Application Publication
(10) Pub. No.: US 2025/0310038 A1
(43) Pub. Date: Oct. 2, 2025

(54) TECHNOLOGIES FOR RADIO LINK CONTROL RETRANSMISSION

(71) Applicant: Apple Inc., Cupertino, CA (US)

(72) Inventors: Ping-Heng Kuo, London (GB); Haijing Hu, Los Gatos, CA (US); Ralf Rossbach, Munich (DE)

(73) Assignee: Apple Inc., Cupertino, CA (US)

(21) Appl. No.: 19/066,717

(22) Filed: Feb. 28, 2025

Related U.S. Application Data
(60) Provisional application No. 63/572,885, filed on Apr. 1, 2024.

(51) Int. Cl. H04L 1/1867; H04W 28/06

(52) U.S. Cl. CPC H04L 1/1887; H04L 1/188; H04W 28/06

(57) ABSTRACT

The present application relates to devices and components, including apparatus, systems, and methods for retransmission prioritization of RLC SDUs.

### CROSS-REFERENCES TO OTHER APPLICATIONS

This application claims priority to U.S. Provisional Application No. 63/572,885, for “TECHNOLOGIES FOR RADIO LINK CONTROL RETRANSMISSION” filed on Apr. 1, 2024, which are herein incorporated by reference in their entirety for all purposes.

### TECHNICAL FIELD

This application relates generally to communication networks and, in particular, to the retransmission of radio link control (RLC) protocol data units (PDUs).

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates aspects of a user equipment in further detail in accordance with some embodiments.

FIG. 3 illustrates a timing diagram in accordance with some embodiments.

FIG. 4 illustrates a radio link control signal flow diagram in accordance with some embodiments.

FIG. 5 illustrates data flow in accordance with some embodiments.

FIG. 6 illustrates aspects of a transmitting entity in accordance with some embodiments.

FIG. 7 illustrates examples of prioritization at a transmitting entity in accordance with some embodiments.

FIG. 8 illustrates another operation flow/algorithmic structure in accordance with some embodiments.

FIG. 9 illustrates other examples of prioritization at a transmitting entity in accordance with some embodiments.

FIG. 10 illustrates another operation flow/algorithmic structure in accordance with some embodiments.

FIG. 11 illustrates another operation flow/algorithmic structure in accordance with some embodiments.

FIG. 12 illustrates another operation flow/algorithmic structure in accordance with some embodiments.

FIG. 13 illustrates a user equipment in accordance with some embodiments.

FIG. 14 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

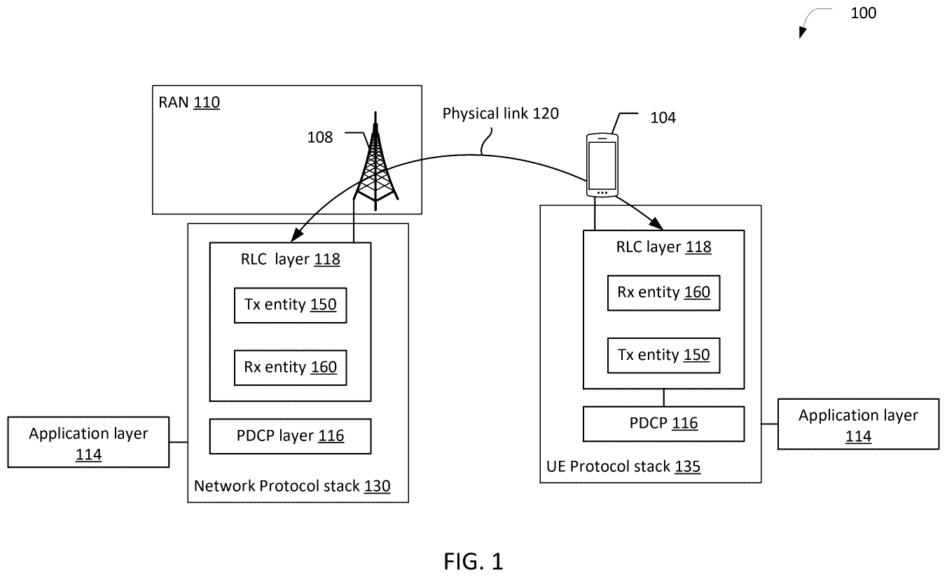

FIG. 1 illustrates a network environment 100 in accordance with some embodiments. The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

The 3GPP TSs may define a protocol stack, e.g., network protocol stack 130 or UE protocol stack 135. The protocol stack may be a set of communication protocols. In some examples, the protocol stack may be designed in a layered architecture for modularity, with each layer providing specific functions. The design may allow changes in one layer without affecting others, facilitating upgrades and improvements. The layers may include a physical layer (Layer 1, L1, or PHY) responsible for establishing and maintaining a physical link 120. Bits of control and data may transmit over the air interface and the physical link 120. The protocol stack, e.g., network protocol stack 130 or UE protocol stack 135, may include a data link layer (Layer 2, L2), which may be divided into a medium access control (MAC), a radio link control (RLC) 118, and a packet data convergence protocol (PDCP) 116 sub-layers. Layer 2 may be responsible for managing the UE 104 connectivity and movement between cells and networks. In some instances, application layer 114 is not included in the protocol stack.

The RLC 118 sub-layer may be responsible for reliable data transmission. The RLC 118 may include a transmitting entity 150 and a receiving entity 160. The transmitting entity 150 at the transmitting end may segment the data from higher layers, e.g., PDCP layer 116 or application layer 114, and add sequence numbers and headers. These packets may then be transmitted over the air interface, e.g., via the physical link 120. At the receiver end, the receiving entity 160 of the RLC layer 118 may reassemble the packets back into the original data, e.g., using the sequence numbers and header information to ensure correct order and to detect any missing packets. If a packet is detected as missing or erroneous, the RLC layer 118 at the receiver can request retransmission from the transmitter.

In the downlink transmission, the base station 108 is the transmitting end, and the UE 104 is the receiving end. The transmitting entity 150 of the RLC 118 of the base station 108 sends the packets via the physical link 120 to the UE 104. The receiving entity 160 of the RLC layer 118 of the UE 104 receives and reassembles the packets. In some embodiments, the packet transmitted by an RLC layer 118 may be referred to as an RLC protocol data unit (PDU).

The receiving entity 160 of RLC layer 118 of the base station 108 may be called a peer entity to the transmitting entity 150 of RLC layer 118 of the UE 104. Similarly, the receiving entity 160 of RLC layer 118 of the UE 104 may be called a peer entity to the transmitting entity 150 of RLC layer 118 of the base station 108.

In some instances, a packet received by a layer from higher layers is called the service data unit (SDU) of that layer. The packet transmitted by the layer to lower layers is called the PDU of that layer. For example, packets received to PDCP layer 116 are called PDCP SDUs, and packets sent from PDCP layer 116 to RLC layer 118 are called PDCP PDUs.

The RLC layer 118 may be configured as an acknowledgment mode (AM) RLC. In AM RLC, each transmitted PDU is assigned a sequence number. The receiver may send acknowledgments (ACKs) for correctly received PDUs and negative acknowledgments (NACKs) for missing or erroneous PDUs. Upon receiving a NACK, or in the absence of an ACK associated with a PDU, the transmitter may retransmit the corresponding PDU.

In some embodiments, the application layer 114 may generate packets and group them in PDU sets. The PDCP layer 116 may receive the packets and generate PDCP PDUs. Each PDCP PDU may be associated with one or more application layer packets or a PDU set. The RLC layer 118 may receive the PDCP PDUs and generate RLC PDUs. Each RLC PDU may be associated with one or more PDCP PDUs and similarly may be associated with one or more application layer packets or a PDU set.

In some embodiments, when a PDCP SDU is received from the upper layer, the transmitting PDCP entity may start a discard timer. The discard timer may track the buffered time of each SDU at the PDCP layer 116. In some instances, when the discard timer expires for a PDCP SDU or the successful delivery of the PDCP SDU is confirmed, e.g., via an ACK, the transmitting PDCP entity may discard the PDCP SDU along with the corresponding PDCP PDU.

In some instances, discarding PDCP SDUs that are not successfully delivered may cause the retransmission of the entire PDU set associated with the discarded PDCP SDUs. Retransmission of the entire PDU set associated with discarded PDCP SDUs may be unnecessary and inefficient, waste network resources, increase latency, and/or negatively impact the user experience. It is desirable to prevent PDCP SDU discarding due to discard timer expiry.

In some embodiments, when RLC PDUs are delivered to lower layers for transmissions, a copy of the RLC PDU may be buffered for retransmission. The RLC PDU may remain in the retransmission buffer until the receiver side of the RLC receives an ACK or a NACK associated with the RLC PDU. If an ACK is received, the RLC PDU is removed from the retransmission buffer. However, if a NACK is received, the transmitting side of the RLC may retransmit the RLC PDU. In some instances, the RLC PDUs in the retransmission buffer may stall or prevent the initial transmission of new RLC PDUs. To expedite moving PDUs out of the retransmission buffer, a transmitting entity, the transmitting entity 150 of the base station 108, may poll its peer receiving entity, e.g., the receiving entity 160 of the UE 104. The polling may request transmission of a status report carrying the ACKs or NACKs associated with the RLC PDUs transmitted by the transmitting entity 150.

The transmitting entity 150 may start a poll retransmit timer associated with the polling request sent to the peer receiving entity 160. Poll retransmit timer may be an RLC operation-related time, e.g., a t-PollRetransmit timer. Once the poll retransmit timer has expired, the transmitting entity 150 may consider RLC PDUs in the retransmission buffer for retransmission.

In some embodiments, when the poll retransmit timer is expired, the transmitting entity 150 may consider delay-critical RLC SDUs among the RLC SDUs submitted to the lower layer for retransmission.

In some embodiments, when the poll retransmission timer has expired, the transmitting entity 150 may consider the remaining time until discarding it to determine which RLC SDU should be considered for retransmission. For example, the transmitting entity 150 may consider the RLC SDU corresponding to PDCP SDUs with the smallest remaining time until discarding.

In some embodiments, the prioritization rule, in addition to considering delay-criticality, may consider whether the AMD RLC PDU contains RLC SDU or SDU segments that correspond to one or more packets of an important PDU set or a less important PDU Set. Whether a PDU Set is important or less important may be determined based on the PDU Set importance (PSI) associated with the PDU Set.

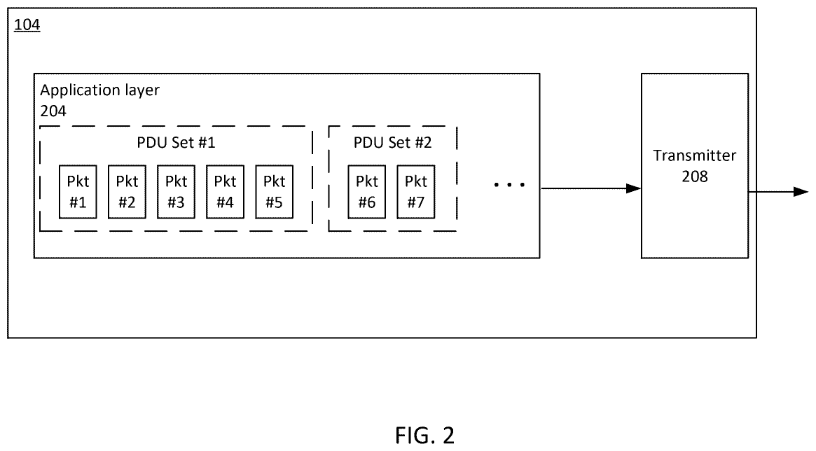

FIG. 2 illustrates aspects of the UE 104 in further detail in accordance with some embodiments. The UE 104 may include an application layer 204 that generates application traffic to be transmitted to another device through the network environment 100. In some embodiments, the application layer 204 may have an XR application that generates XR traffic. However, embodiments are not limited to XR use cases.

For XR and other services, the application layer 204 may generate PDU sets, with individual PDU sets comprising one or more packets. A packet also referred to as a PDU, may be an Internet protocol (IP) packet or a non-IP packet. As shown, PDU set #1 may include packets #1-#5, while PDU set #2 includes packets #6 and #7. Each PDU set may be mapped to a different QoS flow. Different PDU sets may be mapped to different traffic flows when they correspond to different traffic flows or modalities.

The packets of a PDU set may carry a payload of one unit of information generated by the application layer. The unit of information may be a frame or video slice for XR Services, such as those defined in 3GPP Technical Report (TR) 26.926 v18.1.0 (2024-01), for example. In some implementations, all PDUs in the PDU Set may be needed by an application layer at a destination node to allow the application layer to recover parts or all of the information unit. In other implementations, the application layer on the destination node may still be able to recover parts or all of the information unit, even if some PDUs of a PDU set are missing.

In some embodiments, the data produced by an application layer of the UE 104 may include multi-modal data. Multi-modal data may include input data from different devices/sensors or output data to different destinations (e.g., one or more UEs) desired for the same task or application. Multi-modal data may include more than one single-modal data (e.g., one type of data), and there may be a strong dependency among each single-modal data associated with multi-modal data.

In some embodiments, the data produced by an application layer may be in a data burst. A data burst may include, for example, data produced by the application layer in a short period of time. The data burst may include PDUs from one or more PDU Sets.

The PDU sets may be provided to a transmitter 208 of the UE 104. The transmitter 208 may be configured to execute a communication protocol stack, for example, UE protocol stack 135 of FIG. 1, to facilitate communication via the network environment 100. The transmitter 208 may implement L2 and L1 functionality. At the L2 level, transmitter 208 may include a service data adaptation protocol (SDAP) layer, a PDCP layer, an RLC layer, and a MAC layer. At the L1 level, the transmitter 208 may include a physical (PHY) layer. Briefly, the SDAP layer may manage QoS flow handling between the QoS flows and the data radio bearers (DRBs). The PDCP layer may manage robust header (de)compression and security between DRBs and RLC channels. The RLC layer may manage (re-)segmentation and error correction through automatic repeat requests (ARQ) between logical channels and RLC channels. The MAC layer may manage scheduling/priority handling, (de)multiplexing, and hybrid automatic repeat request (HARQ) processes between logical channels and transport channels. The PHY layer may manage the processing of the physical data and control channels.

In some embodiments, various information may be provided by the core network node to the RAN 110 to assist in handling QoS flows and PDUs. This information may be consistent with that described in 3GPP TR 23.700-60 v18.0.0 (2022-12-21). This information may include semi-static information for both uplink and downlink, PDU set QoS parameters, and dynamic information for downlink.

The semi-static information for both uplink and downlink may be provided via the control plane (NGAP). This information may include periodicity for uplink and downlink traffic of the QoS Flow via time-sensitive communications assistance information (TSCAI)/time-sensitive communications assistance container (TSCAC); and traffic jitter information (e.g., jitter range) associated with each periodicity of the QoS flow.

The PDU set QoS parameters may include a PDU Set Error Rate (PSER) to define an upper bound for the rate of PDU Sets that have been processed by the sender of a link layer protocol but that are not successfully delivered by the corresponding receiver to the upper layer. See, for example, 3GPP TR 23.700-60. In some instances, a PDU set may be considered as successfully delivered when all PDUs of a PDU Set are delivered successfully. In other instances, other definitions of successful delivery may be made. In some instances, if one PDU of a PDU set is discarded, all remaining PDUs of the PDU set may be discarded.

The PDU set QoS parameters may further include a PDU Set Delay Budget (PSDB) that defines a time between the reception of a first PDU and the successful delivery of a last-arrived PDU of a PDU Set. See, for example, 3GPP TR 23.700-60. The PSDB may be an optional parameter in various embodiments.

The PDU set QoS parameters may further include a PDU Set importance (PSI) to indicate the relative importance of a PDU set compared to other PDU sets within the same QoS flow.

A PDU set may be associated with the following information: a PDU set sequence number (SN); a PDU set size (in bytes); a PDU SN within a PDU Set; an end PDU of the PDU Set indication; a PDU set importance (PSI); and an end of data burst indication in the header of a last PDU of the data burst. The PSI may be used to identify the importance of a PDU Set within a QoS flow. The RAN 110 may use the PSI for PSI-based discarding in the presence of congestion, as described herein.

The application, application server, application function, or application layer 114 may assign a PSI level for each packet or PDU set or may define rules and policies for assigning a PSI level to a type of packet or PDU set. For example, the application may assign a PSI level to packets associated with audio data and a different PSI to packets or PDU sets associated with real-time video data. The application may assign different PSI to payloads associated with different video frame types within a video stream. PSI level selection may be influenced by factors such as type of application (e.g., video, audio, text), details of codec (e.g., H.264 or high-efficiency video coding, HEVC), level of error propagation when a PDU set is discarded, or inter-dependency among PDU sets (e.g., whether a PDU set is necessary for the processing of some other PDU sets). The PSI selection may be similar to that described in 3GPP TS 26.522 v 0.4.0 (2024-03-01).

PSI may have N levels, e.g., levels 0 to N−1. The higher PSI level values may be associated with less importance. Some of the PSI levels may indicate no interdependency with other PDU sets. For example, there may be 16 levels of PSIs, e.g., level 0 to level 15. PSI levels 14 and 15 may indicate no inter-dependency to other PDU sets; e.g., a PDU set having PSI level 14 may not have inter-dependency to other PDU sets. PDU sets with other PSI levels, e.g., levels 0 to 13, may be needed to process other PDU sets. These values may differ in other embodiments.

In some instances, the base station 108 may instruct the UE 104 to apply different discarding timers for PDU sets with different PSIs. For example, a PDU set with a large PSI level may have a shorter discard timer than a PDU set with a smaller PSI level.

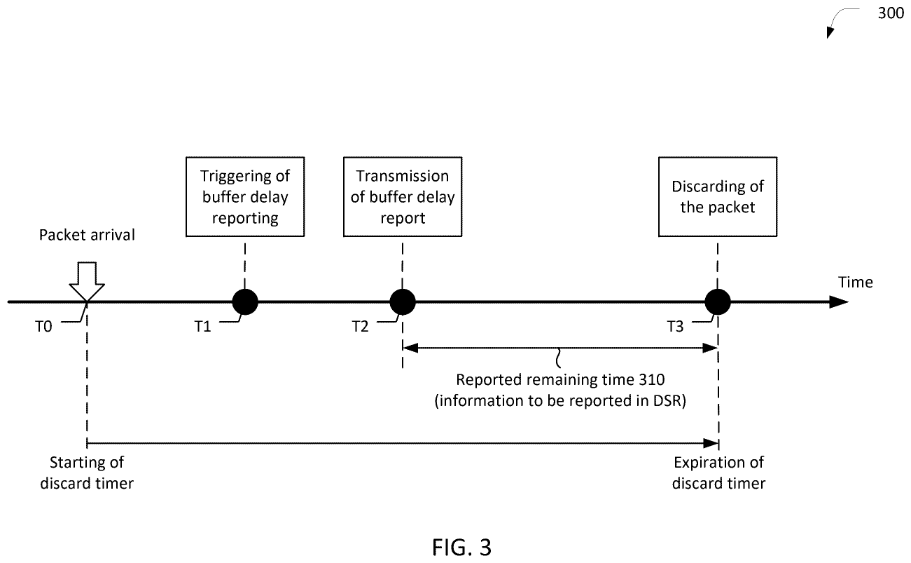

FIG. 3 illustrates a timing diagram 300 for generating and transmitting a delay status report in accordance with some embodiments. The delay status reporting (DSR) may assist in delay-aware scheduling. A DSR may be triggered when the remaining time till the data is discarded is below a threshold.

At T₀, a buffer of a transmitting entity (e.g., UE PDCP transmitting entity in uplink transmission or base station PDCP transmitting entity in downlink transmission) and associated with a logical channel (LCH) or a logical channel group (LCG) can receive a data packet for transmission. At T₀, the transmitting entity can start a discard timer, in which it will discard the data if, by expiration of the timer, the transmitting entity has not successfully transmitted the data packet. At T₁, a first time interval (e.g., T₃-T₁) is reached, where the time remaining prior to the expiration of the discard timer has reached a threshold, such that a delay status report (DSR) is triggered. At T₂, a DSR report is generated and transmitted. The DSR can include data volume information. For example, the DSR may include the buffer size or a reported remaining time 310, when the DSR is transmitted. The reference point for measuring the reported remaining time 310 may be the transmission of DSR. UE may report the DSR in a MAC control element (CE).

As mentioned above, DSR may include buffer size. The UE may determine the buffer size through data volume calculation. 3GPP TS 38.323 v. 18.0.0 (2024-01) describes data volume calculation for delay status reporting.

3GPP TS 38.323 introduces delay-critical PDCP SDUs to calculate buffer size for the DSR. Similarly, 3GPP TS 38.322 v. 18.0.0 (2024-01) introduces delay-critical RLC SDUs to calculate buffer size for DSR.

The delay-critical PDCP SDU may be defined as a PDCP SDU for which the remaining time till discarding is less than a first threshold when PDU set discarding is not configured. When the PDU set discarding is configured, a PDCP SDU is delay-critical if it belongs to a PDU set in which at least one PDCP SDU has the remaining time till discarding less than a second threshold. Note that the remaining time till discarding is the actual remaining time of the discard timer, whereas the reported remaining time 310 is the remaining time on the discard timer at the time of generating or transmitting the DSR. Similarly, a delay-critical RLC SDU is defined as an RLC SDU corresponding to a PDCP PDU indicated as delay-critical by PDCP.

In some instances, for the purpose of MAC delay status reporting, the transmitting PDCP entity may be considered as delay-critical PDCP data volume: 1) the delay-critical PDCP SDUs for which no PDCP Data PDU have been constructed; 2) the PDCP Data PDU that contain the delay-critical PDCP SDUs and have not been submitted to lower layers; 3) the PDCP Control PDUs; 4) for AM data radio bearers (DRBs), the PDCP SDUs to be retransmitted; and 5) for AM DRBs, the PDCP Data PDUs to be retransmitted.

In some instances, for the purpose of MAC buffer status reporting, the UE may consider the following as RLC data volume: 1) RLC SDUs and RLC SDU segments that have not yet been included in an RLC data PDU; 2) RLC data PDUs that are pending for initial transmission; and 3) RLC data PDUs that are pending for retransmission (RLC AM). Additionally, the UE may also consider the following as delay-critical RLC data volume: 1) delay-critical RLC SDUs and delay-critical RLC SDU segments that have not yet been included in an RLC Data PDU; 2) RLC Data PDUs pending for initial transmission and containing a delay-critical RLC SDU or a delay-critical RLC SDU segment; and 3) RLC Data PDUs that are pending for retransmission (RLC AM). In addition, if a status PDU has been triggered and a prohibition timer, t-StatusProhibit, is not running or has expired, the UE may estimate the size of the status PDU that will be transmitted in the next transmission opportunity and consider this as part of RLC data volume for MAC buffer status reporting and as part of delay-critical RLC data volume for MAC delay status reporting.

In some embodiments, an identifier associated with an RLC SDU may indicate whether it is delay-critical, e.g., a one-bit indicator. RLC PDUs may be considered delay-critical if they are associated with delay-critical RLC SDUs or delay-critical RLC SDU segments. RLC Data PDUs of both initial transmission or retransmission may be considered as delay-critical.

In some embodiments, an RLC SDU or SDU segment may be associated with a parameter associated with the discard timer or the PDCP SDU associated with the RLC SDU or SDU segment. The parameter may include a value of the remaining time till discarding, e.g., the remaining time till the discard timer expires.

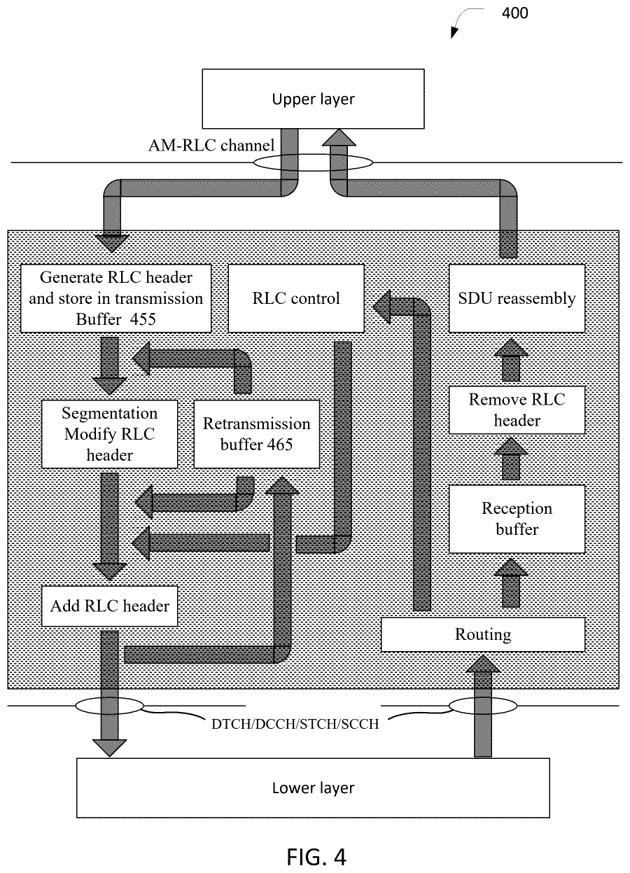

FIG. 4 illustrates an RLC signal flow diagram 400 in accordance with some embodiments. Signal flow diagram 400 is an example of functionalities performed by the RLC layer, e.g., RLC layer 118 in FIG. 1.

An example of an AM RLC entity is described in 3GPP TS 38.322. An AM RLC entity may be configured to submit or receive RL CPDUs through the following logical channels: downlink (DL) or uplink (UL) dedicated control channel (DCCH), DL or UL dedicated traffic channel (DTCH), sidelink control channel (SCCH), and sidelink traffic channel (STCH).

An AM RLC entity may deliver or receive the following RLC Data PDUs: AMD PDU. An AMD PDU may contain either one complete RLC SDU or one RLC SDU segment. An AM RLC entity may deliver or receive the following RLC control PDU: status PDU. The status PDU may be used to provide the status of the PDUs that are correctly received and lost during transmission. It is sent from the RLC receiving entity, e.g., receiving entity 160 in FIG. 1, to the transmitting entity, e.g., transmitting entity 150 in FIG. 1. The status PDU may contain an ACK or NACK sequence number.

The transmitting side of an AM RLC may generate AMD PDU(s) for each RLC SDU. Upon receiving a transmission opportunity from the lower layer, the transmitting side of the AM RLC entity may break down the RLC SDUs into segments. This is done so that the resulting AMD PDUs, with appropriately updated RLC headers, can fit within the total size of the RLC PDU(s) specified by the lower layer.

The transmitting side of an AM RLC entity may also support the retransmission of RLC SDUs or RLC SDU segments. If the RLC SDU or RLC SDU segment to be retransmitted (including the RLC header) exceeds the total size of the RLC DU(s) specified by the lower layer at a given transmission opportunity, the AM RLC entity may break down the RLC SDU into segments or resegment the RLC SDU segments into smaller segments.

When the AM RLC entity on the receiving end receives AMD PDUs, it may identify if there are any duplicated AMD PDUs and discard them. The AM RLC may also recognize if any AMD PDUs have been lost at lower layers and ask its peer AM RLC entity for retransmission. Finally, the AM RLC may reassemble the RLC SDUs from the AMD PDUs it received and pass the RLC SDUs to the upper layer as soon as they are ready.

AM RLC may include two buffers. The first buffer may be the transmission buffer 455. The transmission buffer 455 may store RLC AMD PDUs. After an RLC PDU has been transmitted, a similar copy is stored in the retransmission buffer 465, the second buffer. If the RLC receives a NACK or does not get any positive response, the RLC PDU from the retransmission buffer may be transmitted again.

In some instances, the RLC SDUs are included in RLC PDUs and submitted to a lower layer for transmission. The RLC protocol may track RLC SDUs that have been submitted for transmission and decide to retransmit a buffered RLC PDU based on the associated RLC SDUs.

The transmitting side of an RLC transmitting entity, e.g., transmitting entity 150, may solicit a status PDU from its peer entity at the receiving side. For example, the transmitting entity 150 of the base station 108 may solicit a status PDU from the receiving entity 160 of the UE 104, or the transmitting entity 150 of the UE 104 may solicit a status PDU from the receiving entity 160 of the base station 108.

The transmitting side may solicit a status PDU from its peer entity through the header of an AMD PDU. The transmitting side of a transmitting entity 150 may set a polling flag in the header of an AMD PDU sent to the peer receiving entity 160 and received by the receiving side of the peer receiving entity 160. The transmitting side may set the polling flag when the total number of PDUs transmitted since the last poll exceeds a threshold, e.g., the configured pollPDU threshold; when the total number of bytes transmitted since the last poll exceeds another threshold, e.g., the configured pollByte threshold; when the transmission and retransmission buffer becomes empty after the transmission of the current AMD PDU; when no new RLC SDU can be transmitted after the transmission of the AMD PDU, e.g., due to window stalling; or when the poll retransmit timer expires. Once the polling flag is set, a status PDU from the receiving side is solicited. This mechanism may allow the transmitting side to request its peer to send the current status.

Once the polling flag is set, e.g., by setting the poll bit to ‘1’ in an AMD PDU, the transmitting side may start or restart a poll retransmit timer. For example, the transmitting side may start a configured t-PollRetransmit timer. The timer is stopped when a status PDU is received. If the timer expires, the transmitting side may initiate data retransmission or retransmit the poll.

In some instances, the receiving side may determine which PDUs to report based on the sequence numbers (SNs) and segment offsets (SOs) of the received AMD PDUs. The report may be a control PDU, e.g., status PDU. The receiving side may generate the status report and include the SNs of the received PDUs and the SNs of the lost PDUs or segments. TS 38.322 describes RLC AM polling and associated operations and timers, e.g., the t-PollRetransmit timer.

In some instances, the transmitting side of an AM RLC entity may maintain a transmitting window. The transmitting window may provide orderly transmission of AMD PDUs. It may be used to control the number of PDUs that can be transmitted before receiving an acknowledgment. Two parameters may determine the transmitting window: 1) parameter “AM_Window_Size,” which is the size of the window in terms of the number of PDUs, and 2) parameter TX_Next_Ack, which is the sequence number of the next RLC SDU for which a positive acknowledgment is expected to be received in-sequence. If an AMD PDU has a sequence number, PDU_SN, that is greater than or equal to the TX_Next_Ack and smaller than Tx_Next_Ack+AM_Window_Size, the AMD PDU may be transmitted.

The Tx_Next_Ack may serve as the lower edge of the transmitting window. The Tx_Next_Ack+AM_Window_Size may serve as the upper edge of the transmitting window. A new RLC SDU with SN outside the transmitting window cannot be transmitted. Therefore, it is desirable for the transmitting window to move forward as quickly as possible. When the transmitting window moves forward, the subsequent new packets are less likely to be delayed by window stalling. The transmitting window will move forward by receiving ACK for PDUS with SN equal to Tx_Next_Ack. The transmitter may proactively request ACK or NACK, e.g., via a polling mechanism from the receiver side.

In some instances, some RLC SDUs (or their segments) may be considered for retransmission. For example, when the peer RLC entity does not positively acknowledge some RLC SDUs. Retransmission of an RLC SDU may be performed several times before it is positively acknowledged. In some instances, the number of retransmissions may be capped by a threshold, e.g., configured threshold maxRetxThreshold.

When an RLC SDU or an RLC SDU segment is considered for retransmission, a counter, e.g., configured RETX_COUNTER, may be assigned to the RLC SDU or RLC SDU segment that is being retransmitted. If the RLC SDU or RLC SDU segment is being considered for retransmission for the first time, the counter is set to zero, e.g., RETX_COUNT=0. The counter may be incremented if the RLC SDU or its segment is not pending for retransmission and the RETX_COUNT associated with the RLC SDU has not been incremented due to another NACK in the same status PDU.

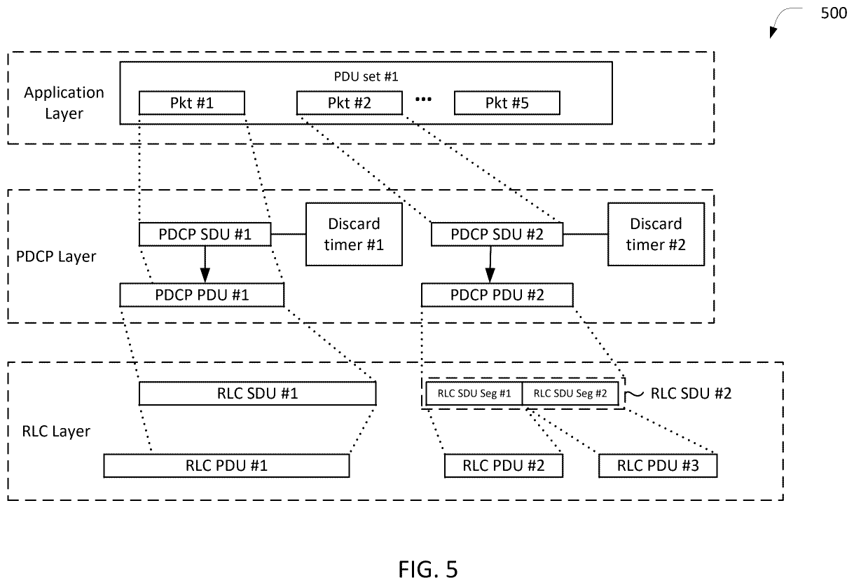

FIG. 5 illustrates data flow 500 in accordance with some embodiments. Data flow 500 is a logical example diagram of protocol layers and the data flow through various layers. Application layer, e.g., application layer 204 in FIG. 2, may generate PDU set #1, including packets #1-#5. Packet #1 of the PDU set #1 may be mapped to PDCP SDU #1. Upon receiving the PDCP SDU #1, the PDCP layer may configure and start a discard timer #1 and associate it with the PDCP SDU #1. Similarly, Packet #1 of the PDU set #1 may be mapped to PDCP SDU #2. Upon receiving the PDCP SDU #2, the PDCP layer may configure and start a discard timer #2 and assign it to the PDCP SDU #2.

PDCP layer may include PDCP SDU #1 in PDCP PDU #1. PDCP PDU #1 may also include a header and other information. Similarly, PDCP SDU #2 may be included in PDCP PDU #2 with other information.

At the RLC layer, PDCP PDU #1 and a PDCP PDU #2 may be included in RLC SDU #1 and RLC SDU #2, respectively. The RLC SDU #1 may be included in the RLC PDU #1 along with RLC header and other information. A segment of the RLC SDU #2, e.g., RLC SDU Seg #1 may be included in RLC PDU #2 along with RLC header and other information, and the second segment of the RLC SDU #2, e.g., RLC SDU Seg #2 along with RLC header and other information may be included in RLC PDU #3.

In a second example, the RLC SDU or PDU may become delay-critical if it is associated with a PDU set where a packet of that PDU set is associated with a delay-critical PDCP SDU. For example, if PDCP SDU #1 becomes delay-critical, in the first example, only RLC SDU #1 and RLC PDU #1 would become delay-critical, and RLC SDU Segment #1, RLC SDU Segment #2, RLC PDU 2 and RLC PDU #3 would not become delay-critical. However, in the second example, when PDCP SDU #1 becomes delay-critical, it is associated with packet #1 of PDU set #1. Therefore, PDCP SDU #2 associated with packet #2 of the PDU set #1 would also become delay-critical. Consequently, PDCP PDU #2, RLC SDU segment #1, RLC SDU Segment #2, RLC PDU #2, RLC PDU #3, PDCP PDU #1, RLC SDU #1, and RLC PDU #1 would become delay-critical.

Due to the nature of PDU sets, in some instances, when a packet becomes delay-critical, many other packets belonging to the same PDU set may also become delay-critical, e.g., when the PDU set discard is configured.

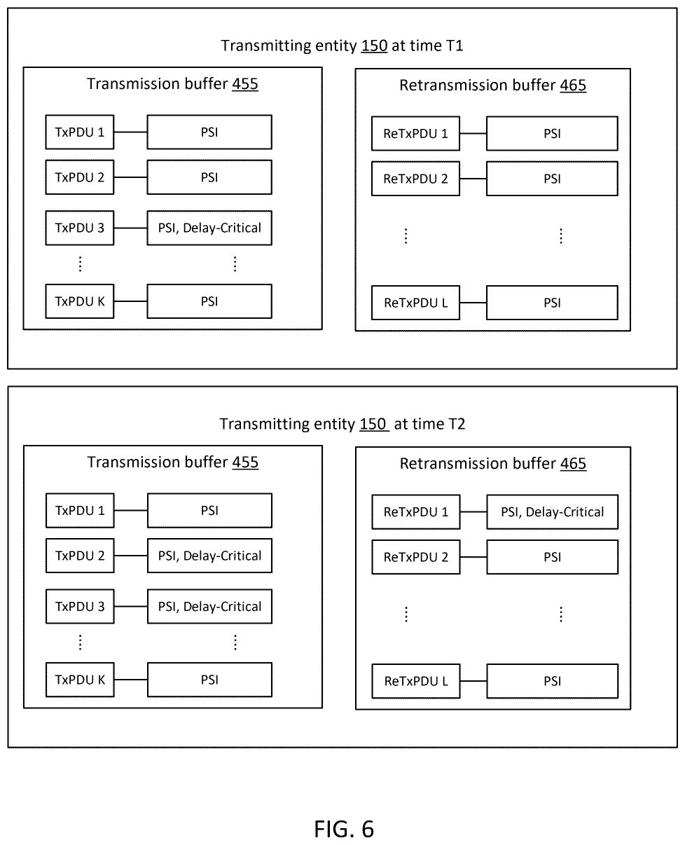

FIG. 6 illustrates aspects of an RLC transmitting entity 600 in accordance with some embodiments. RLC Transmitting entity 150 is illustrated at two different times, T1 and T2. Transmitting entity 150 includes a transmission buffer 455 and a retransmission buffer 465.

At time T1, transmission buffer 455 may store transmitting PDUs 1-K. Only transmitting PDU 3 may be delay-critical. Similarly, retransmission buffer 465 may store retransmitting PDUs 1-L. None of the retransmitting PDUs may be delay-critical. In some instances, information may be associated with each PDU in the transmission buffer 455 or retransmission buffer 465. Information may include a PSI field or a delay-critical indicator.

At time T2, transmitting PDU 2 and retransmitting PDU 1 may become delay-critical. For example, the discarding timer associated with the transmitting PDU 2 and retransmitting PDU 1 may become smaller than a threshold. The transmitting entity 150 at T2 may update information associated with transmitting PDU 2 and retransmitting PDU 1 accordingly to reflect that these PDUs are delay-critical.

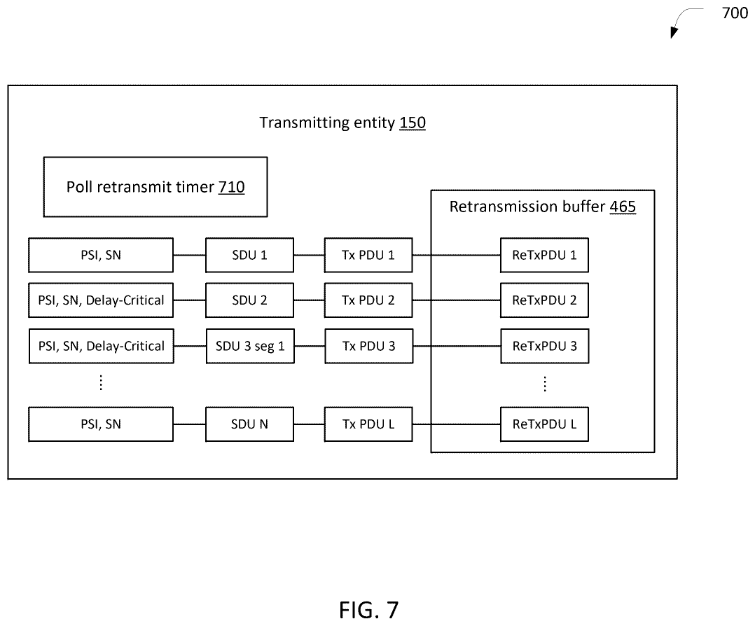

FIG. 7 illustrates examples of prioritization 700 at a transmitting entity 150 in accordance with some embodiments. The transmitting entity 150 may include a retransmission buffer 465. An SDU or an SDU segment may be included in an RLC PDU. The RLC PDU may be submitted to a lower layer for transmission. In some instances, an RLC SDU or SDU segment is said to be submitted to a lower layer for transmission when the corresponding RLC PDU is submitted to a lower layer for transmission.

For example, SDU 1 may be included Tx PDU 1. Once SDU 1 included in Tx PDU 1 is submitted to the lower layer for transmission, a copy, e.g., ReTxPDU 1, is stored in the retransmission buffer 465. The SDU 1 may be associated with important information, e.g., the PSI of the corresponding PDU set. By association, the transmitted PUD, e.g., Tx PDU 1, and the buffered PDU for retransmission, e.g., ReTxPDU 1, are also associated with the importance information and SDU sequence number, SN.

In some instances, the SDU may be a delay-critical SDU. An indicator may be associated with the SDU to indicate that the SDU is a delay-critical SDU. For example, SDU 2 and Segment 1 of SDU 3 are delay-critical SDUs or SDU segments. An indication is associated with SDU 2 to identify SDU 2 as a delay-critical SDU. Similarly, an indication is associated with SDU 3 segment 1 to identify it as a delay-critical SDU segment.

A PDU associated with a delay-critical SDU or SDU segment may be considered delay-critical. For example, Tx PDU 2, which includes SDU 2, may be considered to be delay-critical because it is associated with the delay-critical SDU 2. Similarly, Tx PDU 3 may be considered to be delay-critical because it includes the delay-critical SDU 3 seg 1.

Similarly, the retransmission PDUs corresponding to delay-critical PDUs may be considered delay-critical. In FIG. 7, ReTxPDU 2, associated with delay-critical SDU 2, and ReTxPDU3, associated with delay-critical SDU 3 seg 1, are considered to be delay-critical.

In some embodiments, the PDUs stored in retransmission buffer 465 may stall the initial transmission of new SDUs. In some instances, the initial transmissions of new SDUs are stalled until the PDU associated with the smallest SN is removed from the retransmission buffer 465. A PDU is removed from the retransmission buffer 465 when an ACK associated with that PDU is received in a status report from the peer receiving RLC entity 160.

The transmitting entity 150 may request transmission of a status report by the peer receiving entity 160. For example, the transmitting entity may set a polling flag in a PDU submitted to the lower layer for transmission. The peer receiving entity 160, in response to receiving a polling request, may generate a status report and send it to the transmitting entity 150.

Upon generating or transmitting a polling request, the transmitting entity may start or restart a poll retransmit timer 710. The timer may be stopped when a status PDU is received indicating ACK or NACK information.

Upon the expiry of the poll retransmit timer 710, the RLC layer may initiate data retransmissions or poll retransmissions. For example, upon expiry of the poll retransmit timer 710, the transmitting entity 150 may consider the RLC SDUs submitted to the lower layer for retransmission if both the transmission buffer and retransmission buffer are empty or if no new RLC SDU or RLC SDU segment can be transmitted, e.g., due to window stalling. It is desirable to consider urgent RLC SDU or RLC SDU segments, e.g., based on their respective discard timer, for retransmission.

In some embodiments, when the poll retransmit timer 710 is expired, the transmitting entity 150 may consider delay-critical RLC SDUs or SDU segments among the RLC SDUs submitted to the lower layer for retransmission. The transmitting entity 150 may first consider delay-critical RLC SDUs for retransmission before considering non-delay critical SDUs for retransmission.

In one embodiment, transmitting entity 150 may consider all the delay-critical RLC SDUs that have been submitted to the lower layer for retransmission. Transmitting entity 150 then selects from the delay-critical RLC SDUs for retransmission. For example, the delay-critical RLC SDU associated with the most important PDU set, e.g., having the smallest PSI, may be selected for retransmission.

In one example, the SDU 2 and SDU 3 segment 1 and corresponding ReTxPDU 2 and ReTxPDU 3 may be considered for retransmission. The transmitting entity 150 may compare their PSI to determine which buffered PDU corresponds to a more important PDU set and select that PDU for retransmission.

In one embodiment, the delay-critical RLC SDU with the highest sequence number among the RLC SDUs submitted to the lower layer is selected for retransmission. For example, the transmitting entity 150 may determine the delay-critical SDUs and select the one with the largest SN. Alternatively, the transmitting entity 150 may sort the PDUs in the retransmission buffer 465 based on their SNs and then select the delay-critical SDU with the largest SN.

In one embodiment, the PDUs may be ranked first based on their importance information, e.g., PSI. Then, the transmitting entity 150 may select the PDU with high importance and delay-critical. In another example, the transmitting entity 150 may determine a set of PDUs in the retransmission buffer 465 with PSI smaller than a threshold and select the PDU associated with the largest SN among the selected set of PDUs.

In one embodiment, if none of the RLC SDUs submitted to the lower layer is considered delay-critical, the transmitting entity 150 may behave in accordance with legacy specifications, e.g., consider the buffered SDU associated with the largest SN for retransmission.

In some embodiments, upon expiry of the poll retransmit timer, e.g., t-PollRetrasmit timer as described in TS 38.322, the transmitting side of an AM RLC entity may include a poll in an AMD PDU, e.g., as described in TS 38.322, and if both the transmission buffer 455 and the retransmission buffer 465 are empty (excluding transmitted RLC SDU or RLC SDU segment awaiting acknowledgments); or if no new RLC SDU or RLC SDU segment can be transmitted (e.g., due to window stalling): if any RLC SDU submitted to lower layer is a delay-critical RLC SDU: then consider the delay-critical RLC SDU submitted to lower layer for retransmission, else: consider the RLC SDU with the highest SN among the RLC SDUs submitted to lower layer for retransmission; or consider any RLC SDU which has not been positively acknowledged for retransmission.

In some embodiments, upon expiry the poll retransmit timer, e.g., t-PollRetrasmit timer as described in TS 38.322, the transmitting side of an AM RLC entity may: include a poll in an AMD PDU, e.g., as described in TS 38.322, and if both the transmission buffer 455 and the retransmission buffer 465 are empty (excluding transmitted RLC SDU or RLC SDU segment awaiting acknowledgements); or if no new RLC SDU or RLC SDU segment can be transmitted (e.g., due to window stalling): consider the delay-critical RLC SDU, if any, with the highest SN among the RLC SDUs submitted to lower layer for retransmission; or consider the RLC SDU with the highest SN among the RLC SDUs submitted to lower layer for retransmission; or consider any RLC SDU which has not been positively acknowledged for retransmission.

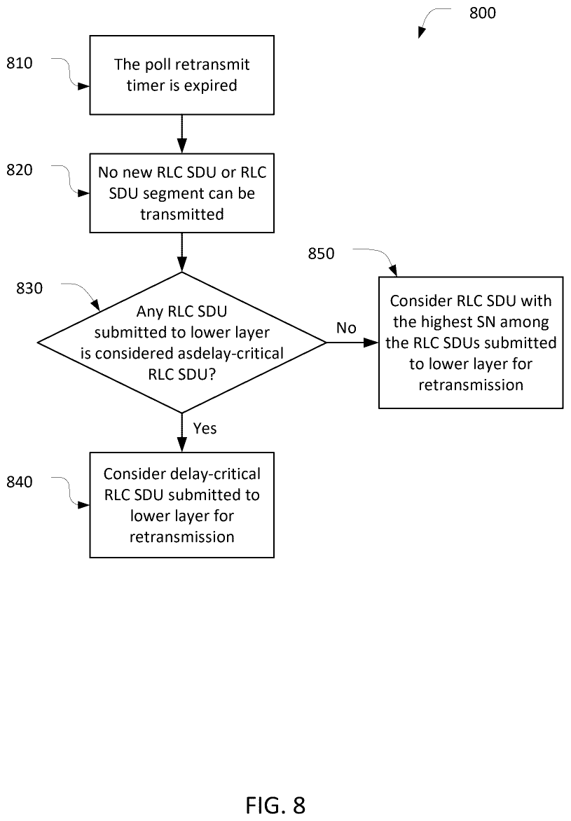

FIG. 8 illustrates another operation flow/algorithmic structure 800 in accordance with some embodiments. The algorithmic structure 800 may be implemented by an RLC transmitting entity such as, for example, the transmitting entity 150 of a UE, such as, for example, the UE 104 or UE 1300, or components thereof, for example, baseband processor circuitry 1304A; or the transmitting entity 150 of a base station, such as, for example, the base station 108 or base station 1400, or components thereof, for example, baseband processor circuitry 1404A.

The operation flow/algorithmic structure 800 may include, at 810, determining or detecting, by the transmitting entity 150, that a poll retransmit timer is expired, e.g., poll retransmit timer 710.

The operation flow/algorithmic structure 800 may include, at 820, determining that no new RLC SDU or RLC SDU segment can be transmitted, e.g., due to window stalling.

The operation flow/algorithmic structure 800 may include, at 830, determining whether any RLC SDU submitted to the lower layer is considered a delay-critical RLC SDU. If one or more delay-critical RLC SDU is submitted to the lower layer, proceed to step 840. Otherwise, if no delay-critical RLC SDU is submitted to the lower layer, proceed to step 850.

The operation flow/algorithmic structure 800 may include, at 840, considering delay-critical RLC SDUs submitted to the lower layer for retransmission, e.g., prioritizing retransmission of delay-critical RLC SDUs over non-delay-critical RLC SDUs.

In some embodiment, the transmitting entity 150 may select, for retransmission, the delay-critical RLC SDU with the largest SN among the delay-critical RLC SDUs submitted to the lower layer.

In some embodiments, the transmitting entity 150 may select, for retransmission, the delay-critical RLC SDU with the lowest, e.g., most important, importance information, e.g., PSI, among the delay-critical RLC SDUs submitted to the lower layer.

The operation flow/algorithmic structure 800 may include, at 850, considering the RLC SDU with the highest SN among the RLC SDUs submitted to the lower layer for retransmission.

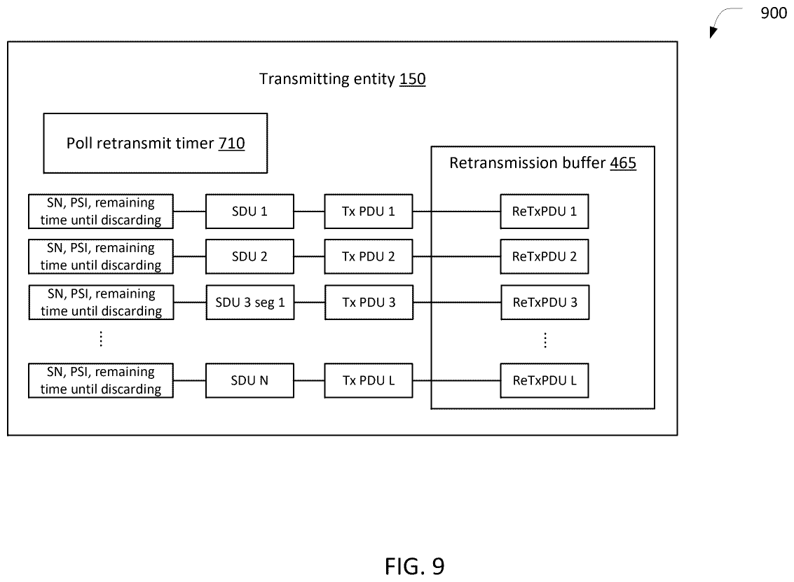

FIG. 9 illustrates other examples of prioritization at a transmitting entity in accordance with some embodiments. The transmitting entity 150 may include a retransmission buffer 465. An SDU or an SDU segment may be included in an RLC PDU. The RLC PDU may be submitted to a lower layer for transmission.

For example, SDU 1 may be included Tx PDU 1. Once SDU 1 included in Tx PDU 1 is submitted to the lower layer for transmission, a copy, e.g., ReTxPDU 1, is stored in the retransmission buffer 465. The SDU 1 may be associated with important information, e.g., the PSI of the corresponding PDU set. By association, the transmitted PUD, e.g., Tx PDU 1, and the buffered PDU for retransmission, e.g., ReTxPDU 1, are also associated with the importance information and SDU sequence number, SN.

The SDU may be associated with a PDCP SDU, and the PDCP SDU may be associated with a discard timer. In some instances, the value of the discard timer is available at the RLC layer, e.g., the transmitting entity 150. Each RLC SDU may be associated with a remaining time until discarding. The smaller the value, the closer the respective PDCP SDU to being discarded. Therefore, it is desired to successfully transmit an RLC SDU corresponding to a PDCP SDU with a short remaining time until discarding.

In some embodiments, when the poll retransmit timer 710 expires, the AM RLC may determine the RLC SDU considered for retransmission based on the remaining time until discarding associated with the RLC SDUs submitted to the lower layer. For example, the transmitting entity 150 may select or consider the RLC SDU corresponding to PDCP SDUs with the smallest remaining time until discarding for retransmission.

In some embodiments, upon expiry of the poll retransmit timer 710, all RLC SDUs corresponding to PDCP SDUs with remaining time smaller than a threshold may be considered for retransmission. The value of the threshold may be configured by the network, e.g., via radio resource control (RRC) configuration signaling.

In some embodiments, the AM RLC may select or consider the RLC SDUs for retransmission if the remaining time until discarding of the corresponding PDCP SDUs falls into a remaining time range upon expiry of the poll retransmit timer 710. The time range may be configured, e.g., via RRC configuration signaling. The AM RLC may select the RLC SDU with the smallest remaining time among the selected RLC SDUs whose remaining time falls into the remaining time range.

In some embodiments, importance information, e.g., PSI, of the PDU set associated with the RLC SDU may take into account for selecting or considering RLC SDUs for retransmission. In one example, upon expiry of the poll retransmit timer, only RLC SDU corresponding to an important PDU set, e.g., with PSI smaller than a threshold or a specified PSI value, may be considered for retransmission. In another example, upon expiry of the poll retransmit timer, only delay-critical RLC SDU corresponding to an important PDU set, e.g., with PSI smaller than a threshold or a specified PSI value, may be considered for retransmission.

In some embodiments, the importance information, e.g., the PSI, may be considered only when the importance-based, e.g., PSI-based, discarding is activated for the corresponding data radio bearer (DRB). If importance-based, e.g., PSI-based, discarding is de-activated for the corresponding DRB, the AM RLC entity may not take PSI into account. For example, if PSI-based discarding is de-activated, any delay-critical RLC SDU may be considered for retransmission when the poll retransmit timer is expired.

All above-mentioned examples, e.g., selection based on delay-criticality, selection based on remaining time until discarding, selection based on PSI, selection based on SN, or their combination, may be enabled or disabled by the network. The network may enable or disable these features by RRC configuration, e.g., a parameter in the RLC configuration information element (IE). In another example, the network may enable or disable these features by dynamic signaling, e.g., downlink control information (DCI), medium access control (MAC) control element (CE), RLC control PDU, or PDCP control PDU.

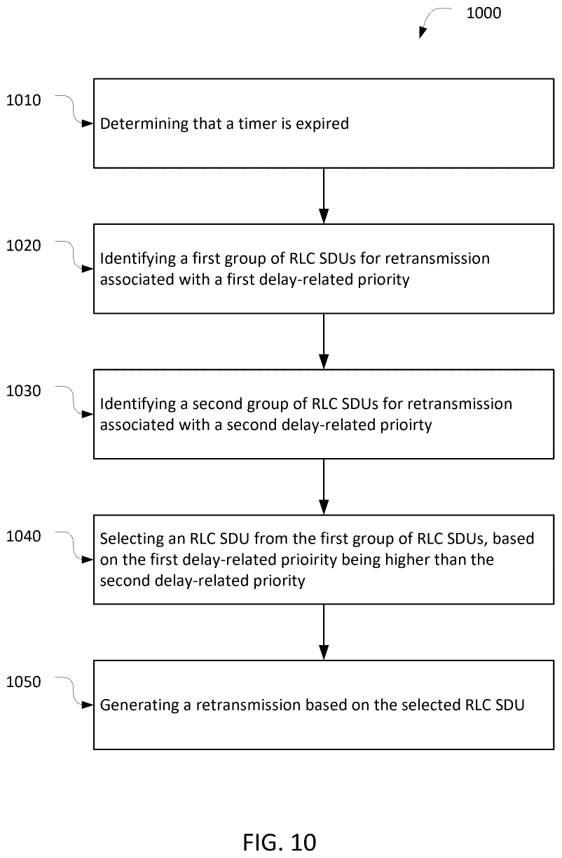

FIG. 10 illustrates another operation flow/algorithmic structure 1000 in accordance with some embodiments. The algorithmic structure 1000 may be implemented by an RLC transmitting entity such as, for example, the transmitting entity 150 of a UE, such as, for example, the UE 104 or UE 1300, or components thereof, for example, baseband processor circuitry 1304A; or the transmitting entity 150 of a base station, such as, for example, the base station 108 or base station 1400, or components thereof, for example, baseband processor circuitry 1404A.

The operation flow/algorithmic structure 1000 may include, at 1010, determining that an RLC operation-related timer is expired. The RLC operation-related timer may be a poll retransmit timer associated with the transmission of a poll flag by a transmitting entity 150 requesting a status report from the peer receiving entity 160. The expiration of the timer may trigger retransmission.

The operation flow/algorithmic structure 1000 may include, at 1020, identifying a first group of RLC SDUs for retransmission associated with a first delay-related priority. The first group of RLC SDUs may be a first plurality of RLC SDUs submitted to the lower layer, wherein each RLC SDU of the first plurality of RLC SDUs is associated with a first delay-related priority. The first delay-related priority may be a priority associated with delay-critical RLC SDUs. The transmitting entity may initiate identifying the first or second group of RLC SDUs in response to expiration of the timer.

The operation flow/algorithmic structure 1000 may include, at 1030, identifying a second group of RLC SDUs for retransmission associated with a second delay-related priority. The second group of RLC SDUs may be a second plurality of RLC SDUs submitted to the lower layer, wherein each RLC SDU of the second plurality of RLC SDUs is associated with a second delay-related priority. The second delay-related priority may be a priority associated with non-delay-critical RLC SDUs.

In some embodiments, the priority of delay-critical RLC SDUs may be higher than that of non-delay-critical RLC SDUs.

The operation flow/algorithmic structure 1000 may include, at 1040, selecting an RLC SDU from the first group of RLC SDUs. The AM RLC may select the RLC SDU for retransmission based on the first delay-related priority being higher than the second delay-related priority. The AM RLC may select the RLC SDU based on the SN or importance information associated with the RLC SDUs of the first group of RLC SDUs.

For example, the AM RLC may select the RLC SDU from the first group of RLC SDUs, e.g., delay-critical RLC SDUs, that has the smallest (or largest) SN.

In another example, the AM RLC may select the most important RLC SDU from the first group of RLC SDUs, e.g., delay-critical RLC SDUs. The most important RLC SDU may be the RLC SDU with the smallest PSI value or a PSI value given to the most important PDU sets.

The operation flow/algorithmic structure 1000 may include, at 1050, generating a retransmission based on the selected RLC SDU. The transmitting entity may generate an RLC PDU that includes the selected RLC SDU and submit it to the lower layer for transmission.

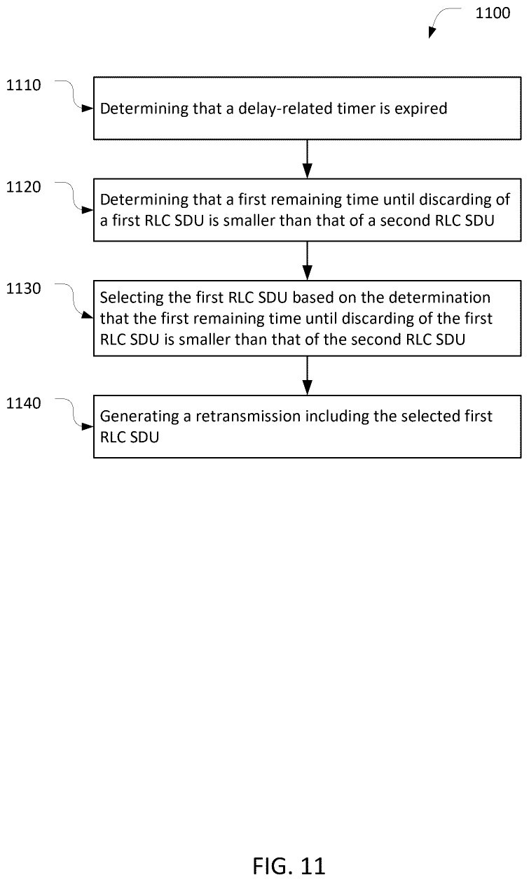

FIG. 11 illustrates another operation flow/algorithmic structure 1100 in accordance with some embodiments. The algorithmic structure 1100 may be implemented by an RLC transmitting entity such as, for example, the transmitting entity 150 of a UE, such as, for example, the UE 104 or UE 1300, or components thereof, for example, baseband processor circuitry 1304A; or the transmitting entity 150 of a base station, such as, for example, the base station 108 or base station 1400, or components thereof, for example, baseband processor circuitry 1404A.

The operation flow/algorithmic structure 1100 may include, at 1110, determining that a RLC operation-related timer is expired. The RLC operation-related timer may be a poll retransmit timer associated with the transmission of a poll flag by a transmitting entity 150 requesting a status report from the peer receiving entity 160.

The operation flow/algorithmic structure 1100 may include, at 1120, determining that a first remaining time until discarding of a first RLC SDU is smaller than that of a second RLC SDU. The remaining time until discarding of an RLC SDU may be based on the discard timer of the associated PDCP SDU.

The operation flow/algorithmic structure 1100 may include, at 1130, selecting the first RLC SDU based on the determination that the first remaining time until discarding of the first RLC SDU is smaller than that of the second RLC SDU.

In some embodiments, determining the remaining time until discarding of an RLC SDU may include: identifying the PDCP SDU associated with the RLC SDU; identifying a discard timer associated with the PDCP SDU; and determining the remaining time until discarding based on the discard timer.

In some embodiment, the RLC transmitting entity 150 may select the RLC SDU among the RLC SDUs whose remaining time until discarding is smaller than a threshold. The threshold may be configured, e.g., via RRC configuration.

In some embodiments, the RLC transmitting entity 150 may select the RLC SDU among the RLC SDUs whose remaining time until discarding is smaller than a first threshold and larger than a second threshold, e.g., their remaining time until discarding falls within a range. The first and second thresholds may be configured, e.g., via RRC signaling.

The operation flow/algorithmic structure 1100 may include, at 1140, generating a retransmission, including the selected first RLC SDU. The transmitting entity may submit a PDU that contains the selected RLC SDU to the lower layer for retransmission.

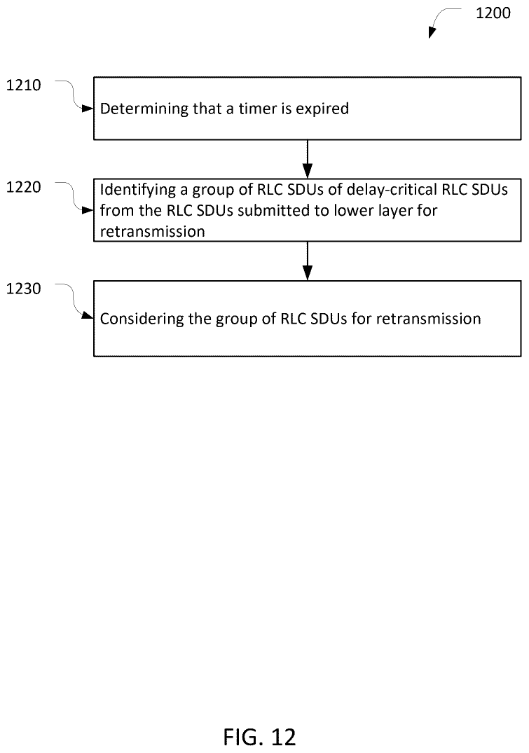

FIG. 12 illustrates another operation flow/algorithmic structure 1200 in accordance with some embodiments. The algorithmic structure 1200 may be implemented by an RLC transmitting entity such as, for example, the transmitting entity 150 of a UE, such as, for example, the UE 104 or UE 1300, or components thereof, for example, baseband processor circuitry 1304A; or the transmitting entity 150 of a base station, such as, for example, the base station 108 or base station 1400, or components thereof, for example, baseband processor circuitry 1404A.

The operation flow/algorithmic structure 1200 may include, at 1210, determining that an RLC operation-related timer is expired. The RLC operation-related timer may be a poll retransmit timer, e.g., t-PollRetransmit timer, associated with the transmission of a poll flag by a transmitting entity 150 requesting a status report from the peer receiving entity 160.

The operation flow/algorithmic structure 1200 may include, at 1220, identifying a plurality of RLC SDUs. Among all RLC SDUs submitted to lower layer, the transmitting entity may identify the RLC SDUs that are associated with a delay-related attribute, e.g., delay-critical.

The operation flow/algorithmic structure 1200 may include, at 1230, considering the plurality of RLC SDUs for retransmission. The transmitting entity may select an RLC SDU from the plurality of RLC SDUs for retransmission. The transmitting entity may select the RLC SDU based on its sequence number, or an importance indicator associated with the RLC SDU. For example, the transmitting entity may select the RLC SDU having the highest (or lowest) sequence number. In another example, the transmitting entity may select the RLC SDU with an importance indicator that is smaller (or greater) than a threshold or is equal to a specified or configured value.

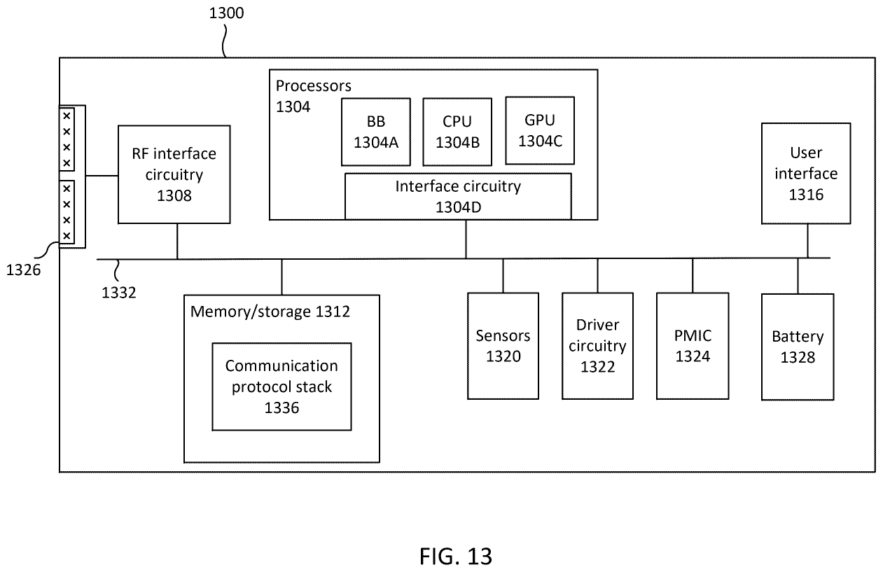

FIG. 13 illustrates a UE 1300 in accordance with some embodiments. The UE 1300 may be similar to and substantially interchangeable with the UE 104.

The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1300 may include processors 1304, RF interface circuitry 1308, memory/storage 1312, user interface 1316, sensors 1320, driver circuitry 1322, power management integrated circuit (PMIC) 1324, antenna 1326, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangements of the components shown may occur in other implementations.

The components of the UE 1300 may be coupled with various other components over one or more interconnects 1332, which may represent any type of interface, input/output, bus (local, system, or expansion), transmission line, trace, or optical connection that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry, or processor circuitry that executes or otherwise operates computer-executable instructions, such as program code, software modules, or functional processes from memory/storage 1312 to cause the UE 1300 to perform operations as described herein. The processors 1304 may also include interface circuitry 1304D to communicatively couple the processor circuitry with one or more other components of the UE 1300.

In some embodiments, the baseband processor circuitry 1304A may access a communication protocol stack 1336 in the memory/storage 1312 to communicate over a 3GPP-compatible network. In general, the baseband processor circuitry 1304A may access the communication protocol stack 1336 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that includes instructions (for example, communication protocol stack 1336) that may be executed by one or more of the processors 1304 to cause the UE 1300 to perform various operations described herein.

The memory/storage 1312 includes any type of volatile or non-volatile memory that may be distributed throughout the UE 1300. In some embodiments, some of the memory/storage 1312 may be located on the processors 1304 themselves (for example, memory/storage 1312 may be part of a chipset that corresponds to the baseband processor circuitry 1304A), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and a radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1326.

In various embodiments, the RF interface circuitry 1308 may be configured to transmit/receive signals in a manner compatible with NR access technologies.

The antenna 1326 may include antenna elements to convert electrical signals into radio waves to travel through the air and to convert received radio waves into electrical signals. The antenna elements may be arranged into one or more antenna panels. The antenna 1326 may have antenna panels that are omnidirectional, directional, or a combination thereof to enable beamforming and multiple input, multiple output communications. The antenna 1326 may include microstrip antennas, printed antennas fabricated on the surface of one or more printed circuit boards, patch antennas, or phased array antennas. The antenna 1326 may have one or more panels designed for specific frequency bands including bands in FR1 or FR2.

The user interface 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1300.

The sensors 1320 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within or connected to the UE 1300. For example, driver circuitry 1322 may include a display driver to control and allow access to a display device, a touchscreen driver to control and allow access to a touchscreen interface, sensor drivers to obtain sensor readings of sensors 1320, and control and allow access to sensors 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

A battery 1328 may power the UE 1300, although in some examples, the UE 1300 may be mounted deployed in a fixed location and may have a power supply coupled to an electrical grid. The battery 1328 may be a lithium-ion battery, a metal-air battery, such as a zinc-air battery, an aluminum-air battery, a lithium-air battery, and the like. In some implementations, such as in vehicle-based applications, the battery 1328 may be a typical lead-acid automotive battery.

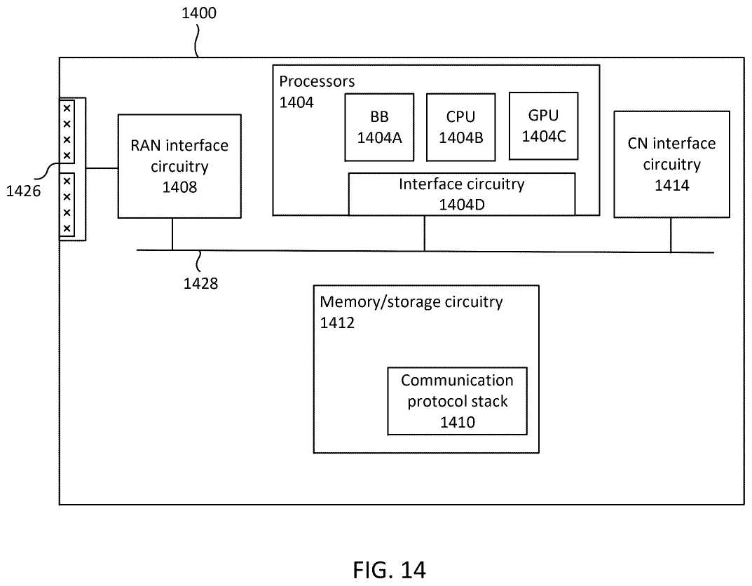

FIG. 14 illustrates a network device 1400 in accordance with some embodiments. The network device 1400 may be similar to and substantially interchangeable with base station 108.

The network device 1400 may include processors 1404, RF interface circuitry 1408 (if implemented as a base station), core network (CN) interface circuitry 1414, memory/storage circuitry 1412, and antenna structure 1426.

The components of the network device 1400 may be coupled with various other components over one or more interconnects 1428.

The processors 1404, RF interface circuitry 1408, memory/storage circuitry 1412 (including communication protocol stack 1410), antenna structure 1426, and interconnects 1428 may be similar to like-named elements shown and described with respect to FIG. 13.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage circuitry 1412 to cause the UE 1300 to perform operations as described herein. The processors 1404 may also include interface circuitry 1404D to communicatively couple the processor circuitry with one or more other components of the network device 1400.

The CN interface circuitry 1414 may provide connectivity to a core network, for example, a 5^{th} Generation Core network (5GC) using a 5GC-compatible network interface protocol such as carrier Ethernet protocols or some other suitable protocol. Network connectivity may be provided to/from the network device 1400 via a fiber optic or wireless backhaul. The CN interface circuitry 1414 may include one or more dedicated processors or FPGAs to communicate using one or more of the aforementioned protocols. In some implementations, the CN interface circuitry 1414 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes a method including: determining that a RLC operation-related timer is expired; identifying a first plurality of radio link control (RLC) service data units (SDUs) submitted to a lower layer for retransmission, wherein each RLC SDU of the first plurality of RLC SDUs is associated with a first delay-related priority; identifying a second plurality of RLC SDUs submitted to a lower layer for retransmission, wherein each RLC SDU of the second plurality of RLC SDUs is associated with a second delay-related priority; selecting an RLC SDU of the first plurality of RLC SDUs based on the first delay-related priority being higher than the second delay-related priority; and generating a retransmission based on the RLC SDU.

Example 2 includes the method of example 1 or some other examples herein, wherein the first delay-related priority is a priority associated with a delay-critical SDU and the second delay-related priority is a priority associated with a non-delay-critical SDU.

Example 3 includes the method of examples 1 or 2 or some other examples herein, wherein a delay-critical SDU has a higher priority over a non-delay-critical SDU.

Example 4 includes the method of any of examples 1-3 or some other examples herein, wherein the first plurality of RLC SDUs includes all delay-critical RLC SDUs submitted to the lower layer.

Example 5 includes the method of any of examples 1-4 or some other example herein, wherein the RLC SDU is a first RLC SDU, and selecting the RLC SDU of the first plurality of RLC SDUs includes: selecting the first RLC SDU having a sequence number that is greater than a sequence number of a second RLC SDU submitted to the lower layer.

Example 6 includes the method of any of examples 1-5 or some other example herein, further including: processing a new RLC SDU or a new RLC SDU segment; determining that the new RLC SDU or RLC SDU segment cannot be transmitted; and determining the first plurality of RLC SDUs based on said determining that the new RLC SDU or RLC SDU segment cannot be transmitted.

Example 7 includes the method of any of examples 1-6 or some other example herein, further including: processing a configuration; and enabling or disabling said selecting an RLC SDU of the first plurality of RLC SDUs based on the first delay-related priority being greater than the second delay-related priority.

Example 8 includes the method of any of examples 1-7 or some other example herein, wherein the configuration is included in a radio resource control (RRC) configuration, a downlink control indication (DCI), a medium access control (MAC) control element (CE), an RLC control protocol data unit (PDU), or a packet data convergence protocol (PDCP) control PDU.

Example 9 includes the method of any of examples 1-8 or some other example herein, further including: identifying a protocol data unit (PDU) set importance (PSI) corresponding to RLC SDUs submitted to the lower layer for retransmission; wherein identifying the first plurality of RLC SDUs includes: determining that: each RLC SDU of the first plurality of RLC SDUs is associated with a first delay-related priority; and each RLC SDU of the first plurality of RLC SDUs is associated with a PSI that is smaller than a threshold.

Example 10 includes the method of any of examples 1-9 or some other examples herein, further including: processing an activation message or a deactivation message, wherein identifying the first plurality of RLC SDUs is based on the activation message or the deactivation message.

Example 11 includes the method of any of examples 1-10 or some other examples herein, further including: processing a configuration including the threshold.

Example 12 includes a method including: determining that a RLC operation-related timer is expired; determining that a first remaining time until discarding associated with a first radio link control (RLC) service data unit (SDU) is smaller than a second remaining time until discarding associated with a second RLC SDU; selecting the first RLC SDU based on said determining that the first remaining time until discarding associated with the first RLC SDU is smaller than a second remaining time until discarding associated with a second RLC SDU; and generating a retransmission including the first RLC SDU.

Example 14 includes the method of example 12 or some other example herein, wherein determining the first remaining time until discarding associated with the first RLC SDU including: identifying packet data convergence protocol (PDCP) service data units (SDUs) associated with the first RLC SDU; identifying all RLC SDUs associated with the PDCP SDUs; and including all RLC SDUs associated with the PDCP SDUs in the retransmission.

Example 14 includes the method of examples 12 or 14 or some other examples herein, further including: processing a configuration including a threshold; and determining that the first remaining time until discarding is smaller than a threshold.

Example 15 includes the method of any of examples 12-14 or some other example herein, further including: processing a configuration including a first threshold and a second threshold; and determining that the first remaining time until discarding is greater than the first threshold and is smaller than the second threshold.

Example 16 includes the method of any of examples 12-15 or some other example herein, further including: processing a configuration; and enabling or disabling said selecting the first RLC SDU based on said determining that the first remaining time until discarding associated with the first RLC SDU is smaller than a second remaining time until discarding associated with a second RLC SDU.

Example 17 includes the method of any of examples 12-16 or some other example herein, wherein the configuration is included in a radio resource control (RRC) configuration, a downlink control indication (DCI), a medium access control (MAC) control element (CE), an RLC control protocol data unit (PDU), or a packet data convergence protocol (PDCP) control PDU.

Example 18 includes the method of any of examples 12-17 or some other example herein, further including: identifying a protocol data unit (PDU) set importance (PSI) corresponding to RLC SDUs submitted to a lower layer for retransmission; and determining that the PSI of the firs RLC SDU is smaller than a threshold.

Example 19 includes the method of any of examples 12-18 or some other example herein, further including: processing an activation message or a deactivation message, wherein determining that the PSI of the first RLC SDU is smaller than a threshold is based on the activation message or the deactivation message.

Example 20 includes the method of any of examples 12-19 or some other examples herein, further including: processing a configuration including the threshold.

Example 21 includes a method including: determining that a radio link control (RLC) operation-related timer is expired; identifying a plurality of RLC service data units (SDUs) of RLC SDUs submitted to a lower layer for retransmission, wherein each RLC SDU of the plurality of RLC SDUs is associated with a delay-related priority; and considering the plurality of RLC SDUs for retransmission.

Example 22 includes the method of example 21 or some other examples herein, wherein the RLC operation-related timer is a t-PollRetransmit timer.

Example 23 includes the method of examples 21 or 22 or some other examples herein, wherein the delay-related priority is a priority associated with a delay-critical SDU.

Example 24 includes the method of any of examples 21-23 or some other examples herein, wherein the delay-critical SDU has a higher priority over a non-delay-critical SDU.

Example 25 includes the method of any of examples 21-24 or some other examples herein, wherein the plurality of RLC SDUs includes all delay-critical RLC SDUs submitted to the lower layer.

Example 26 includes the method of any of examples 21-25 or some other examples herein, further including: selecting an RLC SDU of the plurality of RLC SDUs for retransmission.

Example 27 includes the method of any of examples 21-26 or some other example herein, wherein the RLC SDU is a first RLC SDU, and selecting the RLC SDU of the plurality of RLC SDUs includes: selecting the first RLC SDU having a sequence number that is greater than a sequence number of a second RLC SDU of the plurality of RLC SDUs.

Example 28 includes the method of any of examples 21-27 or some other example herein, further including: processing a new RLC SDU or a new RLC SDU segment; determining that the new RLC SDU or RLC SDU segment cannot be transmitted; and determining the plurality of RLC SDUs based on said determining that the new RLC SDU or RLC SDU segment cannot be transmitted.

Example 29 includes the method of any of examples 21-28 or some other examples herein, further including: processing a configuration; and enabling or disabling said identifying the plurality of RLC SDUs based on the delay-related priority.

Example 30 includes the method of any of examples 21-29 or some other example herein, wherein the configuration is included in a radio resource control (RRC) configuration, a downlink control indication (DCI), a medium access control (MAC) control element (CE), an RLC control protocol data unit (PDU), or a packet data convergence protocol (PDCP) control PDU.

Example 31 includes the method of any of examples 21-30 or some other example herein, further including: identifying a plurality of importance indicators corresponding to the RLC SDUs submitted to the lower layer for retransmission; wherein identifying the plurality of RLC SDUs includes: determining that: each RLC SDU of the plurality of RLC SDUs is associated with a first delay-related priority; and each RLC SDU of the plurality of RLC SDUs is associated with an importance indicator of the plurality of importance indicators that is smaller than a threshold.

Example 32 includes the method of any of examples 21-31 or some other examples herein, wherein the importance indicator is a protocol data unit (PDU) set importance.

Example 33 includes the method of any of examples 21-32 or some other examples herein, further including: processing an activation message or a deactivation message, wherein identifying the plurality of RLC SDUs is based on the activation message or the deactivation message.

Example 34 includes the method of any of examples 21-33 or some other examples herein, further including: processing a configuration including the threshold.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-34, or any other method or process described herein.

Another example may include an apparatus comprising logic, modules, or circuitry to perform one or more elements of a method described in or related to any of examples 1-34, or any other method or process described herein.

Another example may include a method, technique, or process as described in or related to any of examples 1-34, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-34, or portions thereof.

Another example may include a signal as described in or related to any of examples 1-34, or portions or parts thereof.

Another example may include a datagram, information element, packet, frame, segment, PDU, or message as described in or related to any of examples 1-34, or portions or parts thereof, or otherwise described in the present disclosure.

Another example may include a signal encoded with data as described in or related to any of examples 1-34, or portions or parts thereof, or otherwise described in the present disclosure.

Another example may include a signal encoded with a datagram, IE, packet, frame, segment, PDU, or message as described in or related to any of examples 1-34, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-34, or portions thereof.

Another example may include a computer program comprising instructions, wherein execution of the program by a processing element is to cause the processing element to carry out the method, techniques, or process as described in or related to any of examples 1-34, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail. numerous variations and modifications will become apparent to those skilled in the art once the above disclosure is fully appreciated. It is intended that the following claims be interpreted to embrace all such variations and modifications.

What is claimed is:

1. A method comprising:
determining that a radio link control (RLC) operation-related timer is expired;
identifying, based on expiration of the RLC operation-related timer, a plurality of RLC service data units (SDUs) of RLC SDUs submitted to a lower layer for retransmission, wherein each RLC SDU of the plurality of RLC SDUs is associated with a delay-related priority;
selecting an RLC SDU of the plurality of RLC SDUs for retransmission based on the RLC SDU being associated with the delay-related priority; and
generating a retransmission based on the RLC SDU.

2. The method of claim 1, wherein:
the delay-related priority is a priority associated with a delay-critical SDU; and
the delay-critical SDU has a higher priority over a non-delay-critical SDU.

3. The method of claim 1, wherein the plurality of RLC SDUs includes all delay-critical RLC SDUs submitted to the lower layer.

4. The method of claim 1, wherein the RLC SDU of the plurality of RLC SDUs is a first RLC SDU, and said selecting an RLC SDU of the plurality of RLC SDUs for retransmission based on the RLC SDU being associated with the delay-related priority comprises:
selecting the first RLC SDU of the plurality of RLC SDUs that has a first sequence number that is greater than a second sequence number of a second RLC SDU of the plurality of RLC SDUs.

5. The method of claim 1, further comprising:
processing a new RLC SDU or a new RLC SDU segment;
determining that the new RLC SDU or RLC SDU segment can not be transmitted; and
determining the plurality of RLC SDUs based on said determining that the new RLC SDU or RLC SDU segment can not be transmitted.

6. The method of claim 1, further comprising:
processing a configuration, wherein the configuration is included in a radio resource control (RRC) configuration, a downlink control indication (DCI), a medium access control (MAC) control element (CE), an RLC control protocol data unit (PDU), or a packet data convergence protocol (PDCP) control PDU; and
enabling or disabling said identifying the plurality of RLC SDUs based on the delay-related priority.

7. The method of claim 1, further comprising:
identifying a plurality of importance indicators corresponding to the RLC SDUs submitted to the lower layer for retransmission;
wherein identifying the plurality of RLC SDUs includes:
determining that:
each RLC SDU of the plurality of RLC SDUs is associated with a first delay-related priority; and
each RLC SDU of the plurality of RLC SDUs is associated with an importance indicator of the plurality of importance indicators that is smaller than a threshold; and
wherein the importance indicator is a protocol data unit (PDU) set importance.

8. The method of claim 7, further comprising:
processing an activation message or a deactivation message, wherein identifying the plurality of RLC SDUs is based on the activation message or the deactivation message; and
processing a configuration including the threshold.

9. An apparatus comprising:
a processing circuitry to:
determine that a radio link control (RLC) operation-related timer is expired;
identify, based on expiration of the RLC operation-related timer, a plurality of RLC service data units (SDUs) of RLC SDUs submitted to a lower layer for retransmission, wherein each RLC SDU of the plurality of RLC SDUs is associated with a delay-related priority;
selecting an RLC SDU of the plurality of RLC SDUs for retransmission based on the RLC SDU being associated with the delay-related priority; and
generating a retransmission based on the RLC SDU; and
an interface circuitry coupled with the processing circuitry to enable communication.

10. The apparatus of claim 9, wherein:
the delay-related priority is a priority associated with a delay-critical SDU; and
the delay-critical SDU has a higher priority over a non-delay-critical SDU.

11. The apparatus of claim 9, wherein the plurality of RLC SDUs includes all delay-critical RLC SDUs submitted to the lower layer.

12. The apparatus of claim 9, wherein the RLC SDU of the plurality of RLC SDUs is a first RLC SDU, and to select an RLC SDU of the plurality of RLC SDUs for retransmission based on the RLC SDU being associated with the delay-related priority the processing circuitry is further to:
select the first RLC SDU of the plurality of RLC SDUs that has a first sequence number that is greater than a second sequence number of a second RLC SDU of the plurality of RLC SDUs.

13. The apparatus of claim 9, wherein the processing circuitry is further to:
process a new RLC SDU or a new RLC SDU segment;
determine that the new RLC SDU or RLC SDU segment can not be transmitted; and
determining the plurality of RLC SDUs based on said determining that the new RLC SDU or RLC SDU segment can not be transmitted.

14. A method comprising:
determining that a radio link control (RLC) operation-related timer is expired;
determining, based on expiration of the RLC operation-related timer, that a first remaining time until discarding associated with an RLC service data unit (SDU) is smaller than a second remaining time until discarding associated with a second RLC SDU;
selecting a first RLC SDU based on said determining that the first remaining time until discarding associated with the first RLC SDU is smaller than a second remaining time until discarding associated with a second RLC SDU; and
generating a retransmission based on the first RLC SDU for retransmission.

15. The method of claim 14, wherein determining the first remaining time until discarding associated with the first RLC SDU comprises:
identifying packet data convergence protocol (PDCP) service data units (SDUs) associated with the first RLC SDU;
identifying a discard timer associated with the PDCP SDUs; and
determining the first remaining time until discarding associated with the first RLC SDU.

16. The method of claim 14, further comprising:
processing a configuration including a threshold; and
determining that the first remaining time until discarding is smaller than a threshold.

17. The method of claim 14, further comprising:
processing a configuration including a first threshold and a second threshold; and
determining that the first remaining time until discarding is greater than the first threshold and is smaller than the second threshold.

18. The method of claim 14, further comprising:
processing a configuration, wherein the configuration is included in a radio resource control (RRC) configuration, a downlink control indication (DCI), a medium access control (MAC) control element (CE), an RLC control protocol data unit (PDU), or a packet data convergence protocol (PDCP) control PDU.; and
enabling or disabling said selecting the first RLC SDU based on said determining that the first remaining time until discarding associated with the first RLC SDU is smaller than a second remaining time until discarding associated with a second RLC SDU.

19. The method of claim 14, further comprising:
identifying importance information corresponding to the first RLC SDU, wherein the importance information is a protocol data unit (PDU) set importance (PSI); and
determining that the importance information of the firs RLC SDU is smaller than
a threshold.

20. The method of claim 19, further comprising:
processing an activation message or a deactivation message, wherein determining that the PSI of the first RLC SDU is smaller than a threshold is based on the activation message or the deactivation message; and
processing a configuration including the threshold.
